(19) United States
(12) Patent Application Publication
(10) Pub. No.: US 2004/0148200 A1
(43) Pub. Date: Jul. 29, 2004

(54) Method for offering insurance protection for a consumer item as an inducement for opening a credit card account

(76) Inventor: Andrew G. Hodges, Richmond, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/349,951

(22) Filed: Jan. 24, 2003

(51) Int. Cl. G06F 17/60

(52) U.S. Cl. 705/4; 705/39; 455/422.1

(57) ABSTRACT

As an inducement for a consumer to obtain a credit card and open a credit card account, insurance against theft, damage, or loss of a consumer item, such as a cellular telephone, is provided to the consumer if the consumer purchases the item with the credit card or arranges for automatic billing of recurrent service charges associated with the item to the credit card account.

### FIELD OF THE INVENTION

This invention relates to a method of offering insurance protection for a consumer item, such as a cellular telephone, as an inducement to the consumer to obtain a credit card and to charge certain expenses associated with the purchase and/or use of the consumer item to the credit card account.

### BACKGROUND OF THE INVENTION

With lower prices and increased availability, cellular telephones have become more and more popular. Research conducted in 2002 indicated that roughly 62% of adults in the United States owned a cellular telephone and that the number of cellular telephone owners in the United States had risen by 29% from 2000 to 2002. It has been predicted that the number of cellular telephone subscribers in the United States will reach 137 million in 2002 and will grow to 157 million by 2005. Another study indicated that as of 2002, 51% of teenagers, 61% of college aged Americans, 60% of those between 25 and 29 years of age, 68% of those between 30 and 34 years of age, 62% of those between 35 and 54 years of age, and 50% of those 55 and older in the United States owned a cellular telephone.

As more and more people own cellular telephones, and as the phones become smaller and more compact, the likelihood of these items getting lost, damaged, or stolen increases. Relatively few people appreciate the importance of having insurance protection against lost, damage, or theft for such items.

Retail insurance is available for cellular telephones and other consumer items. Retail insurance is insurance coverage that the consumer/phone owner specifically requests and purchases. Often, cellular phone service providers will offer insurance coverage for an additional monthly fee added to the monthly subscriber fee. In addition, many credit card companies provide general buyer protection plans that will, in certain circumstances, reimburse a customer in the event that an item of merchandise that is purchased with the credit card becomes damaged within a certain period of time after purchase. Such insurance, which is known as wholesale insurance, is automatically provided to the consumer; a consumer need not specifically request it or pay an additional fee for the insurance.

Credit card companies are often seeking additional ways to enhance cardholder loyalty and to encourage cardholders to use the card for as many purchases as possible. As inducements to using a credit card, some credit card companies will offer reward points to the credit card holder in exchange for the holder making certain purchases with the credit card. Accumulated reward points can be exchanged for valuable services and merchandise. Common examples of such programs are credit card companies that offer frequent flyer miles (for example, one mile per dollar spent with the credit card) in exchange for usage of the credit card. Still other credit card companies (e.g., Discove®/NOVUS®) will offer as a cash rebate a certain percentage of the total purchases made with the credit card over a predefined period of time, such as one year.

Many services and memberships require payment of recurrent usage fees, typically known as subscriber fees and membership fees. The fees are typically payable on a monthly basis, and the regular payment of the fee entitles the subscriber/member to the continued services and benefits associated with the subscription/membership.

More and more, such recurrent usage fees can be charged to a credit card account. Charging such fees to a credit card account is beneficial to the issuer of the credit card (typically a bank and possibly one or more co-sponsors) because it generates increased usage of the credit card and creates the possibility of interest income if the account balance is not fully paid when due. Charging recurrent fees to a credit card also provides a benefit to the billing entity because it results in quicker payment of its bills and reduces the likelihood of bills going unpaid. The cardholder/participant receives a benefit by not receiving multiple recurrent bills and by only needing to make a single payment to the credit card issuer for all credit card charges, including charges for recurrent fee bills.

U.S. Pat. No. 6,222,914 to McMullin describes a system and program whereby a credit card company offers reward points to its cardholder/participants if recurrent service charges (e.g., phone, utilities, etc.) are billed to the cardholder's credit card account.

There are, however, no credit card sponsors which offer, as an inducement to charging recurrent usage fees to the credit card account, insurance for protection of a consumer item, the use of which requires that the consumer pay a recurrent usage fee. Morever, there are no credit card sponsors which offer a consumer, as an inducement for the consumer to obtain a credit card, insurance specifically protecting against theft, damage, or loss of a cellular telephone purchased with the credit card.

### SUMMARY OF THE INVENTION

The present invention overcomes the shortcomings of prior credit card incentive programs while at the same time addressing the increasing need for consumers to have insurance protection for consumer items, such as cellular telephones. In accordance with aspects of the present invention, a system and method of inducing a consumer to obtain a credit card and charge certain expenses associated with the purchase and/or use of the consumer item to a credit card account is provided as is a system and method for administering such an inducement program.

According to one aspect of the invention, an inducement is provided to encourage a consumer to use a credit card to pay a recurrent usage fee for a consumer item, the use of which requires that the consumer pay the recurrent usage fee. A credit card company issues a credit card to a consumer and opens a credit card account for the consumer. The credit card company also permits the consumer to arrange for the recurrent usage fee to be automatically billed to the credit card account. Insurance protection is offered to the consumer as protection against an incident that results in the diminished utility of the consumer item to the consumer in return for the consumer charging at least the recurrent usage fee to the credit card account.

The insurance protects the consumer against incidents such as loss, theft, or damage to the consumer item and includes repair or replacement of the item or reimbursement for some portion of the purchase price of the item.

In an inventive method of administering an insurance incentive program, such as that described above, the program administrator causes a credit card to be issued to consumer and a credit account to be opened for the consumer. The administrator tracks whether or not the consumer has arranged for a recurrent usage fee associated with a particular consumer item to be billed to the credit account, and, if the consumer has consented to the recurrent fee being billed to the account, the administrator causes the consumer to be provided with insurance protection against an incident that results in the diminished utility of the consumer item.

According to another implementation of the invention, a method for inducing a consumer to obtain a credit card and open a credit card account is provided whereby insurance protection against theft, damage, or loss of a cellular telephone is offered to the consumer in return for the consumer arranging for a periodic cellular telephone service fee to be automatically charged to the credit card account and/or charging the initial purchase of the cellular telephone to the credit card account.

With these and other aspects, advantages, and features of the invention that will become hereinafter apparent, the nature of the invention may be more clearly understood by reference to the following detailed description of the invention and the appended claims.

### DETAILED DESCRIPTION OF THE INVENTION

The present invention is directed to a method for inducing a consumer to use a credit card to pay a recurrent usage fee for a consumer item, the use of which requires that the consumer pay the recurrent usage fee. It is also directed to a method for inducing a consumer to obtain a credit card and open a credit card account. In the context of the present invention, “credit card” is intended to encompass traditional credit cards, debit cards, smart cards, etc. which are commonly accepted as payment for purchase in place of cash or bank checks. In one implementation of the invention, as described herein, the inducement is made in connection with payment of recurrent subscription fees for the use of a cellular telephone, wherein a cellular telephone is defined as a handheld wireless telephone including standard batteries and standard antennae or a permanently installed mobile phone including standard antennae. The invention is applicable, however, to any consumer item for which there is a recurrent usage fee. Combination personal digital assistants and telephones are included.

The system and method described hereinbelow refers to different entities and the relationships that exist between them. The entities include: an insurance incentive program administrator which employs systems and resources responsible for program enrollment, consumer credit card purchase tracking, and administering insurance claims; a credit card company, which is typically a bank which, perhaps along with one or more co-sponsors, has enlisted the services of the insurance incentive program administrator and is responsible for the traditional bank operations associated with credit cards (e.g.,: card issuance, extension of credit (if required), customer service, etc.); the cardholder/participant who participates in the incentive program by opening a credit card account with the bank and purchasing a cellular telephone with the credit card and/or agreeing to allow the periodic subscription fees to be charged to the credit card account rather than directly to the cardholder; and the insurance carrier which underwrites the insurance incentive program in return for insurance premiums paid for the insurance policies.

In accordance with one implementation of the invention, the credit card company issues a credit card to a consumer and opens a credit account for the consumer. As is conventional, the credit card company may require the consumer to complete an application and demonstrate qualification for the credit card. The credit card may or may not include an annual fee, and each cardholder may have a credit limit that is set based on the cardholder's demonstrated ability to pay outstanding credit charges as evidenced by the cardholder's credit history.

To induce a consumer to obtain the credit card and open an account, the credit card company will, as facilitated by the insurance incentive program administrator, offer card-holders free cellular phone insurance protection against loss, theft, or damage to the card holder's cellular telephone.

To induce the cardholder to use the credit card to pay for a recurrent usage fee, such as a cellular phone subscription fee, the credit card company will offer automatic cellular phone protection insurance to the cardholder, free of any additional charges, if the cardholder arranges to have the subscription fees charged directly to the credit card account instead of to the cardholder. To induce and encourage further charges to the credit card, the credit card company may also require that the cardholder charge the initial purchase of the cellular phone to the credit card account in order to qualify for the insurance.

To further encourage customer loyalty and at least minimum payment on outstanding credit amounts, insurance protection may be contingent upon the cardholder/participant being a holder in good standing (e.g., still having usage fees billed to the credit card account and not delinquent in minimum payment requirements) at the time a claim is made.

The insurance provided is automatic, that is, no registration of the cellular phone is necessary. Once the cardholder has charged at least one specified transaction, i.e., payment of the subscription fee and/or payment of the initial purchase price of the cellular phone, to the credit card, the cardholder is automatically covered by the insurance.

The insurance protects the cardholder in the event of an incident that results in the diminished utility to the cardholder of the cellular phone or other consumer item covered by the insurance. Such incidents include loss, theft, or damage to the cellular phone. The protection may include repair of the telephone, reimbursement of at least some portion of the purchase price of the phone (the amount of which may, for example, be based on the age of the item when lost, damaged, or stolen and a predetermined depreciation schedule), or replacement of the phone with an identical or comparable phone.

In a preferred implementation of the invention, certain limitations in the insurance protection can be implemented. The protection may be limited to a specified period of time from the date of purchase, for example one year. Protection may require that the cardholder make a claim within a specified period of time of the incident, for example 45 days. The insurance protection may also include a deductible, for example $50.00 per claim. The claim amount may be limited to the purchase price of the telephone up to a maximum dollar amount per claim, for example $750.00 per claim. In addition, the insurance may be limited by specifying a maximum number of claims that can be made within a given period of time, for example limiting the cardholder to no more than two claims per twelve month period.

After an incident occurs, the cardholder contacts the insurance incentive program administrator to make a claim. The administrator will verify coverage and send a claim form to the cardholder/insured. As mentioned above, it is preferable that the program require that the claim be reported within a specified period (e.g., 45 days) of the incident. If the claim is for a damaged item, the administrator will facilitate the shipping of the item to the administrator by, for example, forwarding to the cardholder a prepaid shipping package. Once all documentation (and the item itself if necessary) has been received, the program administrator will determine whether to have the covered consumer item repaired or replaced or to reimburse the cardholder for the consumer item. The administrator determines the resolution of the claim and communicates that resolution to the cardholder. The administrator will then coordinate with the insurance carrier underwriter to reimburse the cardholder or have the consumer item repaired or replaced. The administrator will facilitate the repair or replacement of the item, if appropriate, by sending the damaged item to a repair facility or by obtaining a replacement item from a selected merchant. The administrator will also facilitate the return of a repaired or replacement item to the cardholder by either shipping the item to the cardholder, for example via a commercial courier service (e.g. FedEx(g), United Parcel Service, DHL, etc.) or by arranging for the repair facility or replacement item merchant to ship the item to the customer. If the resolution is reimbursement, the administrator will facilitate the reimbursement by, for example, sending the cardholder a check for the reimbursement amount, arranging for the insurance underwriter to send the cardholder a check, or arranging for the credit card company to give the cardholder a credit on the cardholder's account.

The existence of the insurance incentive program as well as instructions for and benefits of program participation can be communicated to new, existing, and potential cardholders by advertising through television, radio, print, and/or the internet as well as through cardholder agreements and other written correspondence sent by the credit card company to the cardholder.

The present invention provides advantages to the credit card company by building loyalty and increasing acquisitions by offering valuable customer protection. In addition, offering such protection can drive spending on the credit card account. The invention also offers an easy to implement insurance program for the credit card company. The cardholder is benefitted by receiving free insurance for a consumer item and having recurring fees billed directly to a credit card account, thereby permitting the cardholder to make one payment to the credit card company to pay both the recurrent fees and other general credit card charges.

Those having ordinary skill in the art will recognize that the system and method of the present invention may be implemented using standard computer data processing equipment tied into standard systems already in place for the issuance, use, and billing of consumer credit card accounts.

While the invention has been described in connection with what are presently considered to be the most practical and preferred implementations, it is to be understood that the invention is not to be limited to the disclosed implementations, but, on the contrary, is intended to cover various modifications and equivalent arrangements, as well as applications to consumer items other than cellular telephones, included within the spirit and scope of the appended claims.

1. A method for inducing a consumer to use a credit card to pay a recurrent usage fee for a consumer item the use of which requires that the consumer pay the recurrent usage fee, said method comprising:
issuing a credit card to a consumer and opening a credit card account for the consumer;
permitting the consumer to arrange for the recurrent usage fee to be automatically billed to the credit card account; and
offering insurance protection to the consumer against an incident that results in the diminished utility of the consumer item to the consumer in return for the consumer charging at least one specified transaction to the credit card account, said at least one specified transaction including arranging for the recurrent usage fee to be automatically billed to the credit card account.

2. The method of claim 1, wherein the consumer item comprises a cellular telephone.

3. The method of claim 1, wherein the incident that results in the diminished utility of the consumer item to the consumer comprises at least one of loss, theft, and damage of the consumer item.

4. The method of claim 1, wherein said at least one specified transaction further includes charging the initial purchase of the consumer item to the credit card account.

5. The method of claim 1, wherein said insurance protection against an incident that results in the diminished utility of the consumer item to the consumer comprises at least one of repair of the consumer item, reimbursement of the purchase price of the consumer item, or replacement of the consumer item with an identical or comparable replacement consumer item.

6. A method for administering a consumer incentive program for inducing a consumer to use a credit card to pay a recurrent usage fee for a consumer item the use of which requires that the consumer pay the recurrent usage fee, said method comprising:
causing a credit card to be issued to a consumer and a credit card account to be opened for the consumer;
tracking whether the consumer has arranged for the recurrent usage fee to be automatically billed to the credit card account; and
causing the consumer to be provided with insurance protection against an incident that results in the diminished utility of the consumer item to the consumer in return for the consumer charging at least one specified transaction to the credit card account, said at least one specified transaction including arranging for the recurrent usage fee to be automatically billed to the credit card account.

7. The method of claim 6, wherein the consumer item comprises a cellular telephone.

8. The method of claim 6, wherein the incident that results in the diminished utility of the consumer item to the consumer comprises at least one of loss, theft, and damage of the consumer item.

9. The method of claim 6, wherein said at least one specified transaction further includes charging the initial purchase of the consumer item to the credit card account.

10. The method of claim 6, wherein said insurance protection against an incident that results in the diminished utility of the consumer item to the consumer comprises at least one of repair of the consumer item, reimbursement of the purchase price of the consumer item, or replacement of the consumer item with an identical or comparable replacement consumer item.

11. The method of claim 10, further comprising determining if resolution of a claim against said insurance will be repair of the consumer item, reimbursement of the purchase price of the consumer item, or replacement of the consumer item with an identical or comparable replacement consumer item.

12. The method of claim 11, further comprising communicating said resolution to the cardholder.

13. A method for inducing a consumer to obtain a credit card and open a credit card account by offering the consumer insurance protection against theft, damage, or loss of a cellular telephone in return for the consumer charging at least one specified transaction to the credit card account, said at least one specified transaction including at least one of (a) arranging for a periodic cellular telephone service fee to be automatically charged to the credit card account, and (b) charging the initial purchase of the cellular telephone to the credit card account.

14. The method of claim 13, wherein said insurance protection comprises at least one of repair of the cellular telephone, reimbursement of the purchase price of the cellular telephone, or replacement of the cellular telephone with an identical or comparable replacement cellular telephone.

15. A method for administering a consumer incentive program for inducing a consumer to use and obtain a credit card and open a credit card account, said method comprising:
causing a credit card to be issued to a consumer and a credit card account to be opened for the consumer;
tracking whether the consumer has charged at least one specified transaction to the credit card account, said at least one specified transaction including at least one of:
(a) arranging for a periodic cellular telephone service fee to be automatically charged to the credit card account, and
(b) charging the initial purchase of a cellular telephone to the credit card account; and
causing the consumer to be provided with insurance protection against theft, damage, or loss of the cellular telephone in return for the consumer charging at least one specified transaction to the credit card account, said at least one specified transaction including at least one of (a) arranging for a periodic cellular telephone service fee to be automatically charged to the credit card account, and (b) charging the initial purchase of the cellular telephone to the credit card account.

16. The method of claim 15, wherein said insurance protection comprises at least one of repair of the cellular telephone, reimbursement of the purchase price of the cellular telephone, or replacement of the cellular telephone with an identical or comparable replacement cellular telephone.

17. The method of claim 16, further comprising determining if resolution of a claim against said insurance will be repair of the cellular telephone, reimbursement of the purchase price of the cellular telephone, or replacement of the cellular telephone with an identical or comparable replacement cellular telephone.

18. The method of claim 17, further comprising communicating said resolution to the cardholder.
